(19) United States
(12) Patent Application Publication
(10) Pub. No.: US 2014/0323257 A1
(43) Pub. Date: Oct. 30, 2014

(54) BELT HAVING A TEXTILE OVERLAY

(71) Applicant: ARNTZ BETEILIGUNGS GMBH & CO. KG, Hoexter (DE)

(72) Inventor: Daniel Pattie Gibson, Hoexter (DE)

(21) Appl. No.: 14/366,697

(22) PCT Filed: Dec. 17, 2012
(86) PCT No.: PCT/EP2012/005192

§ 371 Date: Jun. 19, 2014

(30) Foreign Application Priority Data
Dec. 20, 2011 (DE) 10 2011 121 643.3

(51) Int. Cl. F16G 5/08; B05D 7/00

(52) U.S. Cl. CPC F16G 5/08; B05D 7/52; B05D 2252/02; B05D 2451/00
USPC 474/261; 427/375

(57) ABSTRACT

The invention relates to a power transmission belt, having a base of cast polyurethane (30) and a power transmission zone (3) formed thereon and comprising, at least in contact with the power transmission zone (3), an abrasion-proof textile overlay (1) having an inner impregnation that acts to reduce abrasion by fixing the textile fibres and constitutes a barrier coat for the polyurethane in order to prevent same from passing through the textile with the associated increase in abrasion. For the impregnation, a thermoplastic material (22) having a melting point not below 80° C. is located in the interior of the textile overlay (1) in addition to the textile material and substantially completely fills the interstices between the textile threads (16) or fibres in a central plane (15) of the textile viewed across the area, wherein the polyurethane (30) does not completely penetrate the base of the textile overlay (1), limited by the thermoplastic material (22). For the impregnation, it copolyamide film (2) can be fused into the textile in a pre-treatment step.

The invention relates to a power transmission belt with an elastic substructure of polyurethane and a power transmission zone constructed thereon and also with a textile overlay in contact with the polyurethane of the power transmission zone, to a process for production thereof and a corresponding belt textile.

Textile coatings on belts, in particular toothed belts, are primarily designed to reduce abrasion and, in the case of toothed belts, to stop tearing at the tooth edges and tear propagation in the event of damage in the tooth outside edge.

Polyurethane belts are generally cast directly onto the textile overlay, so it is on the overlay that the polyurethane reacts, crosslinks and solidifies. In the process, it penetrates to at least some extent into the textile and therethrough. As the abrasion-resistant and optionally friction-reducing textile overlay then somewhat wears away during use, the belt polyurethane, which generally has a very high coefficient of friction, comes into direct contact with the power transmission or toothed disk, so there is an abrupt increase in the level of friction there. This is undesirable.

DE 10 2008 055 497 A1 discloses providing an adhesion promoter between the foundational body and the textile overlay of a drive belt in order to avoid excessively deep penetration of the vulcanizate into the textile overlay and to effect better chemical attachment to the textile. The adhesion promoter melts in the course of vulcanization and penetrates into the textile overlay while undergoing co-crosslinking. The process is unsuitable for polyurethane belts, since it prevents the inherently desirable mechanical intermeshing between the polyurethane and the textile and shortens the durability and/or maximum service life of the belt.

U.S. Pat. No. 6,296,588 B1 further discloses endowing the textile overlay of an endless belt with an additional layer of a high-melting thermoplastic. The additional level of abrasion control provided by this, however, only lasts until the thermoplastic on the surface has worn away in use. From that point on, friction is liable to increase very suddenly with the advent at the surface of polyurethane which, in the course of being used to cast the belt, has penetrated the textile through to the thermoplastic layer.

To rectify the increased friction, therefore, it has also already been proposed that the textile overlay be additionally rendered lubricious. This is frequently accomplished with PTFE which, however, tends to break and is too rapidly lost during use as the fibers rub against each other. Such textiles as are additionally rendered lubricious by means of PTFE are known, for example from WO 03/031700 A1 and US 2010/0120566 A1. The US 2010/0120566 A1 proposal is that the woven fabric comprising PTFE fibers should also incorporate low-melting thermoplastic fibers which melt in the event of thermal forcing and fix the PTFE fibers. Since this form of fixing surrounds the PTFE fibers, however, it simultaneously hinders the friction-ameliorating improvement.

The problem addressed by the present invention is that of further developing a belt of the type referred to at the beginning so as to obtain a distinct improvement in service life whilst performance characteristics stay substantially the same across the service life. In particular, the abrasion resistance of the belt textile shall be enhanced and an increase in the coefficient of friction across the service life shall be avoided or minimized.

The problem is solved by the belt as claimed in claim 1, the corresponding production process as claimed in claim 7 and a belt textile endowed according to the invention as claimed in claim 13. Further advantageous embodiments of the invention are recited in the corresponding dependent claims.

The belt of the present invention can in principle be any power transmission belt that possesses a substructure of polyurethane and a power transmission zone constructed thereon. A textile overlay covers the power transmission zone of polyurethane, so this textile overlay and the polyurethane of the belt body or at least of the power transmission zone are in direct contact.

Belts of this type are generally produced by casting the polyurethane onto the already provided textile overlay. The textile overlay is placed in a mold used to form a flat belt, a toothed belt or a V-belt for example. The still unreacted polyurethane is liquid as it is cast onto the textile overlay and solidifies as it reacts on the textile overlay. The textile overlay becomes wholly or partly penetrated with the polyurethane during casting, according to textile density.

However, it is undesirable in the case of power transmission belts in particular that the textile overlay should become completely penetrated with the polyurethane. This is because although even the polyurethane-penetrated textile overlay is capable of preventing tearing or tear propagation and of delivering enhanced abrasion resistance, an excessively large polyurethane fraction at the belt surface would mean that the belt polyurethanes' high coefficient of friction would acquire an excessively large, undesirable influence.

It is accordingly provided according to the present invention that the interior of the textile overlay includes additionally to the textile material a thermoplastic material with a melting point not below 80° C. and preferably with a melting point in the range between 80 and 145° C., preferably between 90 and 135° C., more preferably between 100 and 135° C. and especially between 100 and 130° C. to substantially completely fill the interstices between the textile threads or fibers in a central plane of the textile when viewed across the area. The melting point of the thermoplastic material is determined using, for example, differential scanning calorimetry (DSC) at ambient pressure. The additional thermoplastic material is situated in the core region of the textile where it fills the voids between the fibers of a woven, knitted or nonwoven fabric and/or covers or coats the fibers to some extent at least.

Gaps in the thermoplastic material situated in the core region and/or at least one central plane of the textile can be tolerated to some extent, in particular when thermoplastic material extends in a comparatively low concentration into at least one edge region of the textile, so a good barrier effect is obtained overall. The presence of the thermoplastic material in the core region limits the degree to which the liquid polyurethane is able to penetrate prior to vulcanization in the textile overlay, and serves as a barrier layer, so the textile cannot be completely penetrated with the polyurethane. The central plane in which the thermoplastic material is situated in the textile defines a penetration limit to the polyurethane penetrating from one side into the textile overlay during casting. As a result, the textile overlay, bounded by the thermoplastic material, is not completely penetrated with the polyurethane of the power transmission zone.

The effect of the additional thermoplastic material imported into the textile is, first, to define a barrier layer to the belt polyurethane and, second, to fix the fibers in the interior of the textile relative to each other in order that internal abrasion in the textile may be substantially prevented thereby. This has a particularly positive effect in friction-reducing PTFE-containing textiles. These textiles are immobilized in their interiors by the thermoplastic material to such an extent that this also has an effect on the surface and provides additional wear control there. The effect intensifies the closer the central plane in which the thermoplastic material is situated is situated to the belt outside surface, but still below the outer surface of the textile overlay, or when, as in the second alternative of the present invention, the thermoplastic material has penetrated substantially uniformly and has come to be distributed in a continuous zone between the outer textile surface and the central plane. The degree to which the polyurethane that has penetrated the textile overlay to a substantial degree intermeshes with the textile is particularly good as a result of this measure.

In a particularly preferred embodiment, the thermoplastic material is a copolyamide.

Copolyamides herein refers not only to polymers polymerized from more than two different types of monomer that polymerize to form polyamide but also mixtures of two or more such polymers. The copolyamides in question may in principle consist of one or more diamines in combination with one or more dicarboxylic acids or lactams, optionally in combination with one or more aminocarboxylic acids, other amino-substituted carboxylic acids, etc. The following are mentioned merely by way of example: caprolactam/hexamethylenediamine/adipic acid; hexamethylenediamine/adipic acid/sebacic acid; hexamethylenediamine/tetramethylenediamine/adipic acid; nexamethylenediamine/tetramethylenediamine/azelaic acid; and also products of dicarboxylic acids, diamines and alpha-aminocarboxylic acids and/or lecterns with aliphatic, cycloaliphatic or aromatic amines and/or carboxylic acid, preferably each with 6 to 20 carbon atoms per monomer unit.

Copolyamides further comprehend mixtures of two or more of the aforementioned copolyamides.

Copolyamides further comprehend copolymers comprising polyamide units and further polymerizable units and also mixtures of copolyamides as described above with other polymers that each have a polyamide content of at least 50 wt %.

Specific copolyamides that melt efficiently into manufactured-fiber textiles and are suitable for the invention are referred to in DE 32 48 776 A1 and DE 102 12 889 A1 for example.

The copolyamide or, in general, the thermoplastic material may preferably be modified with a friction-reducing additive. Additives of this type are known to a person skilled in the art. The friction-reducing additive may be selected, for example, from the group polytetrafluoroethylene, graphite, silicone, in particular in the form of silicone oil, molybdenum sulfide and polyvinyl fluoride, including mixtures within the group.

The thermoplastic material, in particular the copolyamide, should have a coefficient of (sliding) friction below 0.45 and preferably below 0.3, or be adjusted thereto with the aforementioned friction-reducing additive.

The thermoplastic material is in melted form in the textile overlay before the polyurethane is cast thereon. This is preferably accomplished in a separate pretreatment step by applying the thermoplastic material to one of the textile surfaces and subsequent melting from this surface such that at least the textile overlay surface facing the adjacent polyurethane of the power transmission zone is (remains) virtually free from the thermoplastic material.

In a first preferred embodiment, the thermoplastic material penetrates into the textile structure in the course of being melted thereonto, i.e., in the course of impregnating the textile overlay, at from 50% to 100% of its weight, so further preferably thermoplastic material is present in the impregnated textile overlay at a basis weight of up to 200 g/m². Preferred values in respect of the basis weight are from 7 to 200 g/m² and preferably from 7 to 150 g/m².

In a further preferred embodiment, the outer surface of the textile overlay, which faces away from the belt polyurethane, has as a result of the thermoplastic sinking in during the melting a proportion of the thermoplastic material in its surface and in its edge region that is lower than the concentration of additional thermoplastic material in that center plane which serves as barrier layer and/or thread-fixing plane. The low proportion of thermoplastic material in the outer layer of the textile overlay, however, does suffice to provide an additional level of fixing to the textile threads while at the same time preventing internal abrasion in the textile.

Both embodiments have the advantage that the polyurethane is able, in casting, to penetrate into the overlay textile unimpededly from the thermoplastic-free side and thus to mechanically intermesh with same.

In a particularly preferred embodiment, the power transmission belt according to the invention is a flat belt, a V-belt or a toothed belt, more preferably a toothed belt.

The textile of the textile overlay can be a woven fabric, a loop-formingly knitted fabric, a loop-drawingly knitted fabric or a nonwoven fabric, preference being given to a woven fabric. The fabrics or textiles in question can be conventional belt textiles as known to a person skilled in the art. Preference is given to textiles comprising manufactured fibers or a manufactured-fiber blend, the textile overlay consisting of or containing these fibers. Particularly preferred manufactured-fiber materials consist of polyamide or polyester or contain such fibers, examples being nylon-6,6, meta-aramid, parearamid, nylon-4,6, and may be endowed with friction-reducing materials, such as polytetrafluoroethylene (PTFE). It is preferable here for PTFE threads to be co-incorporated in the textile, as shown in WO 03/031700 A1 for example.

The process which the invention provides for producing a power transmission belt—especially a power transmission belt as described above—having a substructure of polyurethane and a power transmission zone constructed thereon and also a textile overlay in contact with the polyurethane of the power transmission zone comprises forming the polyurethane on the textile overlay in a conventional manner, and is characterized in that
either a) a thermoplastic material dissolved or suspended in a solvent is applied to a surface of the textile overlay and allowed to penetrate into the textile overlay, whereafter the solvent is evaporated/removed with or without employment of heat, or
b) a thermoplastic material having a melting point below 145° C. is applied in the solid state to a surface of the textile overlay, wherein the thermoplastic material is made to melt by means of heat, such that it penetrates down to an experimentally predetermined depth into the textile structure of the textile overlay,
and in that the polyurethane is applied to the textile overlay thus pretreated according to a) or b) and allowed to react, wherein it penetrates into the adjacent surface of the textile overlay without completely penetrating the textile overlay.

At the same time, the textile threads or filaments are fixed by the melted thermoplastic material.

The process accordingly provides in principle a multi-step process wherein initially the textile overlay is impregnated with the thermoplastic material.

The textile overlay can be impregnated with the thermoplastic material by applying the thermoplastic material dry in solid form (as a powder or foil), or alternatively a solution or suspension of the thermoplastic material can be applied, for example by blade coating. Heat is applied to expel/remove the solvent, while a suspended material may additionally soften or melt, or the solvent is allowed to evaporate at ambient temperature. The viscosity of the solution or suspension has to be such that the thermoplastic material will penetrate into the textile overlay, yet is only minimally present, if at all, at either or both of the textile surfaces, and provides in the interior a good barrier effect against the PU to be applied later by casting.

In a preferred embodiment, a foil of the thermoplastic material is placed flat onto the textile overlay and melted thereinto under heat. The thermoplastic material here penetrates by gravity.

The material may optionally be imported in an even more controlled manner by applying an underpressure to the opposite surface of the textile; alternatively, pressure can be applied to the foil surface.

The thermoplastic material is preferably a copolyamide as already more particularly specified hereinabove. The melting point of the copolyamide or of the rest of the thermoplastic material is preferably between 80 and 145° C., more preferably between 90 and 145° C., more preferably between 90 and 135° C., more preferably between 100 and 135° C. and especially between 100 and 130° C.

To effect the melting/penetration in a first embodiment of the invention, the thermoplastic material penetrates at least 50% of its weight into the textile structure of the textile overlay, preferably in order to be present in the textile overlay at a basis weight of up to 200 g/m².

In a further embodiment, the melting/penetration is effected in a preferable manner such that the highest concentration of the thermoplastic material becomes established in a central plane of the textile overlay.

This central plane can be situated, in relation to the textile overlay thickness, in the center or in a core region or in a plane closer to one of the surfaces, but not at the surface of the textile itself. Owing to the melting, a concentration of thermoplastic material can be situated at one surface of the textile, but said concentration is lower than in the core region and/or the central plane defined by the mode of conducting the process.

After the textile has been impregnated in this way, it can be placed in a mold. In a further step of the process, the polyurethane for the power transmission zone of the belt substructure is applied to the textile overlay thus prepared/impregnated and allowed to react thereon. For this, it penetrates into the adjacent surface of the textile overlay without fully penetrating this overlay. This results in an adequate degree of mechanical intermeshing between the polyurethane and the textile overlay without risk that strongly friction-increasing polyurethane might arrive at the surface of the belt, since the barrier effect due to the impregnation in the interior of the textile overlay prevents this.

The polyurethane is preferably applied from the non-impregnated side of the textile.

Further preferably for certain embodiments, the threads or filaments of the textile of the textile overlay have been rendered friction reducing, for example with PTFE fibers, as already described above.

According to the present invention, the thermoplastic material penetrates deeply into the textile, fixing the textile fibers of the abrasion-resistant textile overlay in the course of penetration. It is advantageous but not mandatory for the thermoplastic material to possess good chemical adhesion to and/or affinity for the textile fibers or parts thereof. This is the case, for example, when a copolyamide used according to the present invention as a relatively low-melting, fiber-fixing thermoplastic material is employed on a belt textile consisting of polyamide or polyester or having a high proportion of polyamide and/or polyester fibers. A decisive advantage of the invention is that the brittle friction-reducing textile fibers, such as PTFE fibers for example, cannot be lost by fracture and internal friction in a “dry” (non-impregnated) textile, but are held in the textile by the impregnation until they have made their maximum possible contribution to friction reduction, i.e., up to their having been worn away completely by abrasion. Considerable improvements in service life are obtained as a result.

The invention further encompasses a belt textile, in particular a toothed belt textile, for use as textile overlay in a power transmission belt of the present invention.

The belt textile of the present invention is a manufactured-fiber textile which optionally contains admixtures of other fibers for example natural fibers such as cotton fibers, in which case the admixtures sum to not more than 40% by volume. This belt textile of the present invention, in addition to the material of the textile fibers, contains in the interstices between the textile threads or fibers and/or as coating on the textile threads or fibers—although not as a coating of all the textile threads—a thermoplastic material which (a) is either virtually not present on either or both of the textile surfaces while its concentration is at its highest in a central plane between the surfaces of the textile, or which (b) is present at and on a surface of the textile and is at least 50 wt % penetrated into the textile overlay.

The belt textile here should preferably contain the thermoplastic material in the textile structure at a basis weight of up to 200 g/m², as already described above.

This belt textile of the present invention can have been melted down for example by the melting into the textile of a thermoplastic material applied to one surface in a pulverulent form or as a foil, in either case preferably under pressure. Alternatively, a solution or suspension of the thermoplastic material can have been applied, for example by blade coating. Heat is used to expel/remove the solvent, while a suspended material can additionally soften or melt, or the solvent is allowed to evaporate. The thermoplastic material is then preferably situated in the core region of the textile, and both surface regions exhibit distinctly lower concentrations of the additional thermoplastic material than the core region. The highest concentration of the thermoplastic material is then situated in a central plane between the surfaces which is disposed substantially parallel between the surfaces. This central plane can be situated exactly in the center of the textile material, relative to the textile thickness, but can also be disposed closer to one of the surfaces.

Preferably, the concentration of the additional thermoplastic material in a central plane or in the entire core region is distinctly higher than to one of the surfaces, while the other surface is completely free from the additional thermoplastic material.

In a preferred exemplary embodiment, this free surface can later define the interface with regard to the belt polyurethane, which can penetrate into the textile unimpededly from this side and become mechanically intermeshed with same in the course of curing. The other surface of the textile, the surface which is the outside surface in usage as textile overlay of a belt, contains but little of the additional thermoplastic material, yet sufficient for the latter also to fix the outer fibers of the textile overlay and protect them from internal abrasion.

The thermoplastic material additionally imported into the belt textile is preferably a copolyamide which may additionally have a friction-reducing modification, as already more particularly described above. It is further preferable for the textile fibers or threads to have been rendered friction reducing. In a particularly preferred embodiment, the textile contains polytetrafluoroethylene fibers, preferably in addition to a higher level of other manufactured fibers. It is particularly preferable for the belt textile to contain a high proportion of polyamide in the base weave, for example above 40 wt.

The invention will now be more particularly described with reference to an exemplary embodiment depicted in the drawing, in which

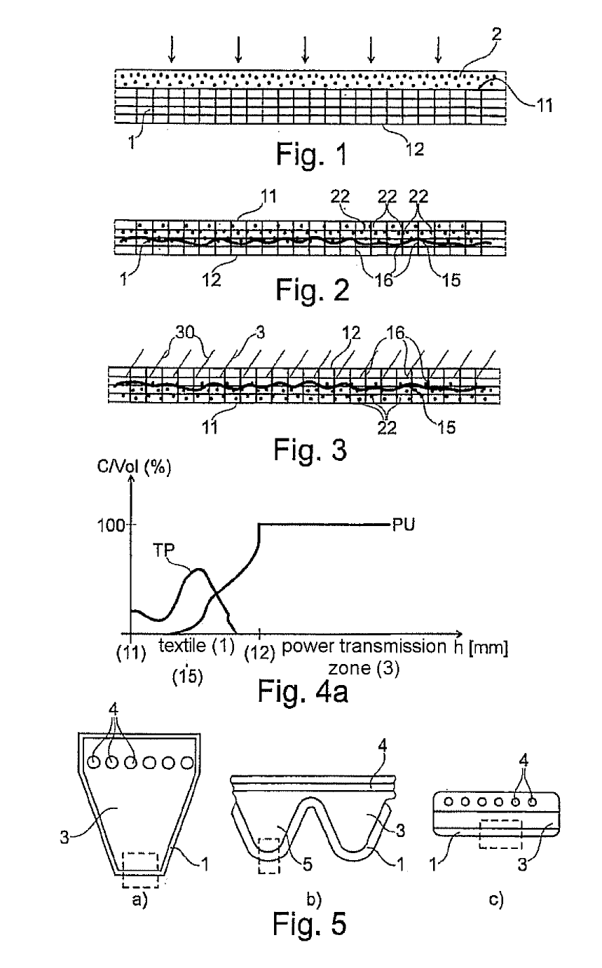

FIG. 1 shows a textile overlay with applied foil of thermoplastic material,

FIG. 2 shows the textile overlay of FIG. 1 with melted thermoplastic material,

FIG. 3 shows the textile overlay of FIG. 2, inverted, with cast polyurethane thereon,

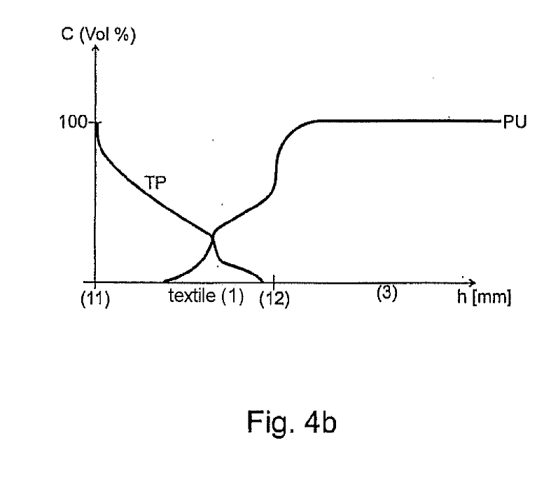

FIGS. 4a) and b) show the concentration ratios of thermoplastic material (TP) and polyurethane (PU), plotted against the height (h) of the belt textile for 2 examples,

FIGS. 5a)-5c) show a schematic depiction of standard belts whereon the invention can be actualized, a) V-belt, b) toothed belt, c) band belt.

FIG. 1 shows an in-principle sketch of a cross section through a textile overlay 1 as it is being prepared for impregnation with an additional thermoplastic material. For this purpose, a foil 2 of thermoplastic material lies flat on the outer surface 11 of textile overlay 1. The dry textile overlay 1 with the thermoplastic foil 2, for example a copolyamide foil of the type used as hot-melt adhesive foil for the textile industry, lying on top is heated as a whole. The heat can be supplied using a heated conveyor belt, in a continuous oven or using a heatable calender. Closed-loop control is used to adjust the temperature at the locus of the textile to the range of about 100 to 160° C. As indicated by the arrows, the material of foil 2 melts and is compelled by its own gravity or by an applied pressure (not depicted here) to pass into the textile overlay 1.

FIG. 2 shows the state of the impregnated textile overlay 1 following completion of the melting of foil 2. Textile overlay 1 retains this structure in the cooled state and can then be further processed. As can be seen, the thermoplastic material 22 has undergone foil liquefaction and completely penetrated into the textile, so but a minimal concentration of thermoplastic material 22 is left on the outer surface of the textile overlay. On the contrary, the material 22 has sunk through to a central plane 15 in the textile overlay 1 to there fix the here merely indicated threads and/or fibers 16 of the textile across the full central plane 15 and produce at the same time a barrier layer by closing the pores which are otherwise present within plane 15 of the textile. The region between the central plane 15 and the outer surface 11 of the textile overlay is the site for additional fixing of fiber due to a relatively lower concentration of thermoplastic material 22.

FIG. 3 shows a further cross-sectional diagram in relation to a subsequent processing step after the polyurethane for the power transmission zone and/or the belt substructure has been applied to the textile overlay 1. For this, the textile overlay 1 impregnated with the thermoplastic material 22 was initially inverted, so the outer surface 11 is face down as it is placed into a mold not depicted here and the inner surface 12 between the belt polyurethane and the textile overlay lies on top. The belt polyurethane 30 of the power transmission zone 3 then penetrates as usual into between the threads 16 of the belt textile of the textile overlay 1, specifically down to the central plane 15 and the barrier layer produced there by the thermoplastic material 22. In the event that gaps appear in the barrier layer due to different sink depths in the impregnating step, for example, the belt polyurethane 30 will additionally intermesh through the central plane 15 with underlying fabric threads in the impregnation region, but will certainly not penetrate as far through as with a corresponding non-impregnated textile overlay 1.

The cross-sectional view in FIG. 3 reveals that, on the one hand, the desired good mechanical intermeshing between belt polyurethane 30 and textile overlay 1 can take place without too much belt polyurethane 30 getting into the vicinity of the later outer surface 11 to there cause in the course of prolonged service lives involving abrasion of the textile, an increase in the coefficient of friction at the continually eroding surface 11. At the same time, the fibers, threads or filaments—which is applicable varies with the type of textile—become fixed by the thermoplastic material 22 to reduce rubbing between the threads and fibers 16, as a result of which especially the relatively stiff polytetrafluoroethylene threads, if present, are less prone to break.

FIG. 4a) illustrates by way of example the approximate concentration profiles of polyurethane and of thermoplastic material across the height, i.e., the thickness, of the textile overlay for the example shown in FIGS. 1 to 3. The polyurethane fraction is 100% by volume within power transmission zone 3. In the region in which the polyurethane passes into the textile overlay at the latter's inner surface 12, which faces the power transmission zone 3, the polyurethane fraction decreases abruptly in favor of the textile material and declines more and more up to the central plane 15. In the region of the central plane 15 of textile overlay 1, the polyurethane concentration again decreases abruptly in the direction of the outside surface 11 of the textile overlay, the surface at which itself there is no longer any polyurethane. The concentration of the thermoplastic polymer (TP) is somewhat higher at the outer surface 11, via which impregnation was effected, than in the region underneath, and has a concentration maximum in the core region of the textile overlay and/or in and around the central plane 15. This is responsible for causing the barrier effect against the polyurethane.

FIG. 4b) shows the approximate concentration profile—plotted as in FIG. 4a)—when the thermoplastic foil (2) was imported into the textile of the overlay at more than 50%, but not 100%, under slight pressure and with less pronounced heating. The content of thermoplastic material (TP) is therefore high at the outer surface (11), only to decrease rapidly by the importation limit. The polyurethane (PU) initially penetrates far into the interior surface (12) of the textile in a relatively unimpeded manner. Barrierness and additional intermeshing in the impregnated textile only come about close to the outer surface (11).

FIGS. 5a) to 5c) show the invention in use with standard belts. The textile overlay (1) is in each case covering the power transmission zones 3 of the belt substructures. What is also shown is the belt-typical arrangement of strength members 4. FIG. 5a) shows a V-belt with complete textile sheathing. The textile overlay 1 encloses the belt completely. FIG. 5b) shows a toothed belt having transversely disposed teeth 5 and longitudinally extending strength members 4. In this case, the textile overlay (1) covers the entire toothed areas including valleys, squirts and flanks. FIG. 5c) shows a flat belt whose textile overlay (1) is confined to the inside area. FIGS. 1 to 3 show sectional regions corresponding to the broken-lined ones in FIG. 5.

In practice, fiber fixing results in a substantial lengthening of the service lives of the belt. The properties of the belt accordingly remain unchanged for a long period.

### EXAMPLE/TEST

A toothed belt was tested. The textile used for covering the teeth was a woven fabric having nylon-6,6 in warp and weft; weight 275 g/m²; 2×2 twill construction, textile extensibility: 80% at 20 newton loading, width of sample specimen 25 mm.

First, a copolyamide foil 50 μm in thickness was laid on top of this woven textile fabric. The melting range of this copolyamide is reported by the manufacturer to be from 110 to 120° C. The foil was melted onto the textile under pressure at somewhat above the melting temperature, in a heatable calender. The heat and pressure settings were such that the textile just absorbed the molten material.

The textile thus impregnated was cooled down and then inverted, introduced into a belt mold, and had a polyurethane applied to it by casting.

The service life of the toothed belt thus obtained increased by a factor of 2 to 3 in relation to a comparable belt without impregnation.

1. A power transmission belt having a substructure of polyurethane and a power transmission zone constructed thereon and also a textile overlay in contact with the polyurethane of the power transmission zone, wherein the interior of the textile overlay includes additionally to the textile material a thermoplastic material with a melting point between 80° C. and 145° C. to substantially completely fill the interstices between the textile threads or fibers in a central plane of the textile when viewed across the area, wherein the textile overlay, bounded by the thermoplastic material, is not completely penetrated with the polyurethane of the power transmission zone.

2. The power transmission belt as claimed in claim 1, wherein the thermoplastic material is a copolyamide.

3. The power transmission belt as claimed in claim 1, wherein the thermoplastic material has been melted into the textile overlay such that at least the textile overlay surface facing the adjacent polyurethane of the power transmission zone is virtually free from the thermoplastic material.

4. The power transmission belt as claimed in claim 1, wherein the belt is a flat belt, a V-belt or a toothed belt.

5. The power transmission belt as claimed in claim 1, wherein the textile of the textile overlay is a woven fabric.

6. The power transmission belt as claimed in claim 1, wherein the textile overlay consists of or contains manufactured fibers or a manufactured-fiber blend.

7. A process for producing a power transmission belt having a substructure of polyurethane and a power transmission zone constructed thereon and also a textile overlay in contact with the polyurethane of the power transmission zone, which comprises forming the polyurethane on the textile overlay, wherein either a) a thermoplastic material dissolved or suspended in a solvent is applied to a surface of the textile overlay and allowed to penetrate into the textile overlay, whereafter the solvent is evaporated/removed with or without employment of heat, or b) a thermoplastic material having a melting point below 145° C. is applied in the solid state to a surface of the textile overlay, wherein the thermoplastic material is made to melt by means of heat, such that it penetrates down to an experimentally predetermined depth into the textile structure of the textile overlay, and in that the polyurethane is applied to the textile overlay thus pretreated according to a) or b) and allowed to react, wherein it penetrates into the adjacent surface of the textile overlay without completely penetrating the textile overlay.

8. The process as claimed in claim 7, wherein a foil of the thermoplastic material is placed flat onto the textile overlay and melted thereinto under heat under further preferably pressure.

9. The process as claimed in claim 7, wherein the thermoplastic material is a copolyamide, preferably with a melting point between 80 to 145° C., preferably between 90° C. and 135° C., more preferably between 100° C. and 135° C. and yet more preferably between 100° C. and 130° C.

10. The process as claimed in claim 7, wherein the thermoplastic material penetrates at least 50% of its weight into the textile structure of the textile overlay, preferably in order to be present in the textile overlay at a basis weight of up to 200 g/m2.

11. The process as claimed in claim 7, wherein the melting is performed such that the highest concentration of the thermoplastic material becomes established in a central plane of the textile overlay.

12. The process as claimed in claim 7, wherein the threads or filaments of the textile of the textile overlay have been rendered friction reducing.

13. A belt textile for use as textile overlay in a power transmission belt as claimed in any of claims 1 to 6, wherein the textile is a manufactured-fiber textile, optionally with admixture of other fibers, and in that in addition to the material of the textile fibers it contains in the interstices between the textile threads or fibers and/or as coating on the textile threads or fibers a thermoplastic material which (a) is virtually not present on either or both of the textile surfaces while its concentration is at its highest in a central plane between the surfaces of the textile, or which (b) is present at and on a surface of the textile and is at least 50 wt % penetrated into the textile overlay.

14. The belt textile as claimed in claim 13, wherein the thermoplastic material is a copolyamide.

15. The belt textile as claimed in claim 13, wherein the textile fibers or threads have been rendered friction reducing.

16. The belt textile as claimed in claim 13, wherein the textile contains PTFE fibers.
